(19) United States
(12) Patent Application Publication
(10) Pub. No.: US 2006/0173908 A1
(43) Pub. Date: Aug. 3, 2006

(54) System and method for automated customization of a workflow management system

(76) Inventors: Michelle M. Browning, Austin, TX (US); Robert P. Welch, Round Rock, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(21) Appl. No.: 11/032,183

(22) Filed: Jan. 10, 2005

(51) Int. Cl. G06F 17/00; G06F 7/00

(52) U.S. Cl. 707/104.1

(57) ABSTRACT

The present invention is directed to a system and method providing an efficient ted customization of an existing workflow management system. Agent software utilized to operate autonomously to instruct a generic workflow tool provided by sting workflow management system to accomplish the customization process direct human supervision. Thus, a non-developer user who does not have dge of the process definition language provided by the workflow management may accomplish a successful customization. Further, the present invention costs and resources to customize an existing workflow management system.

### FIELD OF THE INVENTION

The present invention generally relates to the field of a work flow management system for providing a software system that allows users to define a planned work process, and particularly to an automated customization of LOTUS NOTES™ workflow management system by utilizing agent software.

### BACKGROUND OF THE INVENTION

With the increasing development of information and communication technologies, workflow management systems have been utilized by many organizations to generate increased efficiency. A workflow management system is developed to provide computer automated infrastructure where a group of people can achieve a common goal following some predefined rules and task assignments. Workflow management systems are software systems that allow users to define a planned work process that is made up of a set of steps. Generally, a workflow management system provides a generic workflow model requiring a customization process suitable for each organization. However, customizing an existing workflow management system may be a difficult task for most users since workflows of the organization should be defined using a process definition language provided by the workflow management system. Further, the customization process is potentially error-prone, requiring end to end testing of each customized version of the workflow management system. Thus, a non-developer user may not be able to accomplish a successful customization of the workflow management system.

Therefore, it would be desirable to provide a method and system customizing an existing workflow management system automatically without an intervention of a programmer user.

### SUMMARY OF THE INVENTION

Accordingly, the present invention provides a method and system utilizing agent software to automatically customize an existing workflow management system.

In a first aspect of the present invention, a system utilizing agent software to customize a workflow management system is provided. The agent software may include computer program instructions for an automated customization of a workflow management system. The system may build a template database containing all possible process steps provided by a generic workflow tool which may comprise predefined rules, templates, and access control lists of each step in a work process. An initial configuration profile document may be formed based on the template database.

The system may provide a graphic user interface representing the configuration profile document with a table to receive desired steps from the user. Each element of the table may represent a process step of the workflow management system. After receiving desired steps, the configuration profile document is stored in memory by the agent software. The configuration profile document may be utilized for the agent software to determine which of steps are desired to be included in the customization process. The agent software may instruct the generic workflow tool to build the customized database of a workflow management system based upon the configuration profile document.

In a second aspect of the present invention, a method of an automated customization of a LOTUS NOTES™ database system via agent software is provided. A template database may be generated to contain all possible process steps in the LOTUS NOTES™ database system. A configuration profile document may be formed to have a table including elements each representing a process step based on the template database. The present invention may provide a graphic user interface displaying the configuration profile document in order to receive information of desired process steps from a user. The configuration profile document may be stored to be utilized throughout the customization process. Then, the agent software may initiate LOTUS NOTES™ program codes capable to disable roles of undesired process steps, which alters a workflow chain. Accordingly, the customized LOTUS NOTES™ database system may include desired process steps with altered workflows.

In an advantageous aspect of the present invention, the customization process is transparent from the user. Additionally, the non-programmer user may achieve the customization without using the process definition language provided by the workflow management system. In another advantageous aspect of the present invention, the database design of the new workflow management system may not be different from a generic database design due to the utilization of the agent software and the configuration profile document. Thus, no further testing for the customized workflow management system may be required. Consequently, the present invention reduces costs and resources to customize an existing workflow management system.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a block diagram of a system for customizing a workflow management system in accordance with an exemplary embodiment of the present invention;

FIG. 2 is a flow diagram describing the steps to implement agent software which customizes the workflow of a LOTUS NOTES™ database system in accordance with an exemplary embodiment of the present invention;

FIG. 3 is an illustration of a main navigator screen generated by an Email LOTUS NOTES™ system;

FIG. 4 is an illustration of a Graphic User Interface generated by the agent software of FIG. 2 wherein the agent software is utilized for a migration process of the Email LOTUS NOTES™ system;

FIG. 5 is an illustration of GUI of FIG. 4 wherein a user provides desired step information;

FIG. 6 is an illustration of a Access Control List screen provided by an Email LOTUS NOTES™ system wherein the Access Control List screen displays the roles enabled by the agent software of FIG. 2; and

FIG. 7 is an illustration of a main navigator screen by an Email LOTUS NOTES™ system after the agent software finishes a migration process wherein the main navigator screen displays a new environment for the migrated Email LOTUS NOTES™ system.

### DETAILED DESCRIPTION OF THE INVENTION

Reference will now be made in detail to the presently preferred embodiments of the invention, examples of which are illustrated in the accompanying drawings.

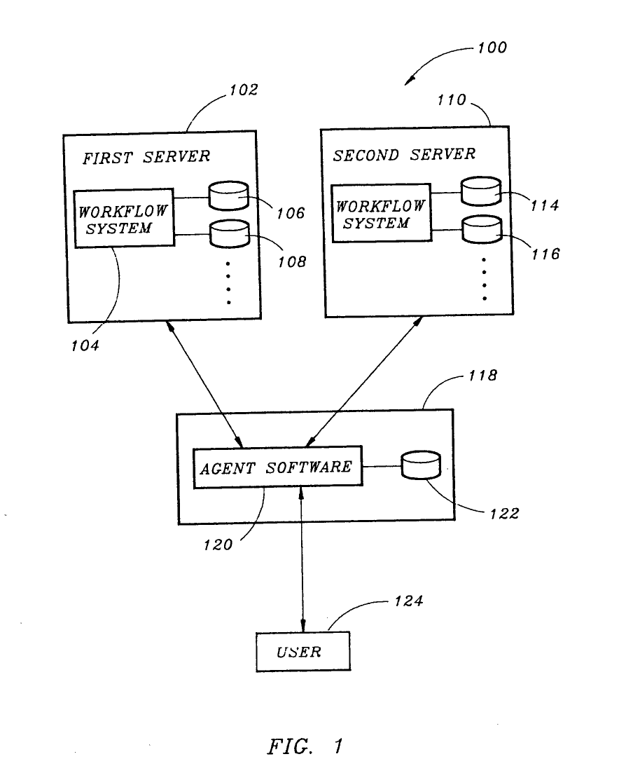

Referring generally now to FIGS. 1 through 7, exemplary embodiments of the present invention are shown.

The present invention is directed to a system and method providing an efficient automated customization of an existing workflow management system. Workflow management systems may include software systems that allow users to define a planned work process that is made up of a set of steps. Most workflow management systems provide a generic workflow model (a general workflow tool) requiring a customization process making the workflow management system suitable for each organization. The present invention may utilize agent software that operates autonomously to instruct the provided generic workflow tool to accomplish the customization process without direct human supervision. Thus, a non-developer user who does not have the knowledge of the process definition language (a part of a generic workflow model) provided by the workflow management system may accomplish a successful customization.

Referring now to FIG. 1, a block diagram 100 of a system providing an automated customization of a workflow management system in accordance with an exemplary embodiment of the present invention is shown.

In a particular embodiment of the present invention, a workflow management application 104 may be provided via a first server 102. The workflow management application may comprise a generic workflow process for a customization process making the workflow management system suitable for an organization. Conventionally, a workflow management system includes a generic workflow process made up of all possible steps in the workflow, predefined tasks to be carried out at each step, the role of people responsible for the task, the documents (templates) needed by the step, the relationship between tasks that show next tasks to be initiated on completion of the task, and the like. The first server 102 may comprise a plurality of databases 106-108 storing a generic workflow process including predefined rules, templates, access control lists (lists of the role of people), or the like. A new workflow process may be defined by using the generic workflow processes, other definition languages or the like. The defined new workflow process may be enacted by other workflow management systems so that the new defined workflow process can be moved from system to system.

A user 124 may utilize agent software 120 coupled to a local database 122 to build a new work flow environment in a second server 110. Alternatively, the agent software may be stored in the first server as a part of the workflow management application 104 and utilize the databases of the first server 102. In general, intelligent agents (agent software) are defined as sets of instructions or programs that operate autonomously to accomplish unique tasks without direct human supervision. The agent software 120 may receive desired steps of the new workflow system from the user, retrieve user role information (e.g. an access control list), and the like. The agent software 120 may store customization information such as desired steps, the user role information, and the like to the database 122. The agent software 120 will instruct the workflow management application 104 in the first server 102 to build a new workflow environment desirable to the user 124 in the second server 110. Such a customization process by the agent software may be transparent to the user 124 and a new database design may not be required for the customization process. Thus, non-developer users may achieve a successful customization of the workflow management system in the second server 110.

In an exemplary embodiment of the present invention, LOTUS NOTES™ may be utilized as a workflow management system. LOTUS NOTES™ is a client/server groupware and email system. The LOTUS NOTES™ server may run on various platforms including WINDOWS® NT, WONDOWS® 2000, Linux, SUN SOLARIS™, IBM ISERIES™, and the like. In general, a LOTUS NOTES™ domain consists of many LOTUS NOTES™ servers, spread over a network. Users registered in the LOTUS NOTES™ domain may be allowed to access databases on any LOTUS NOTES™ server in the domain.

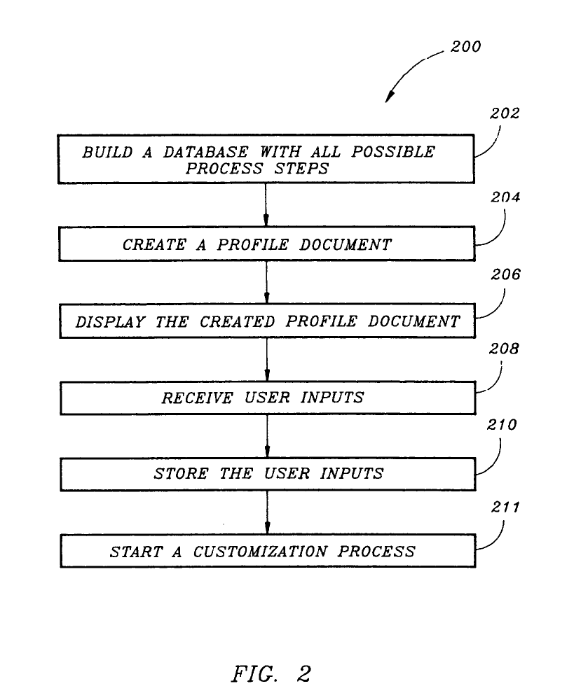

Referring now to FIG. 2, a flow diagram of a process 200 describing the steps to utilize agent software for a customization of LOTUS NOTES™ workflow database in accordance with an embodiment of the present invention is shown. The process 200 may begin with the step in which a template database is built with all possible process steps of LOTUS NOTES™ workflow database 202. Each step of a workflow process may be represented by a view in the LOTUS NOTES™ workflow database. Initially, a configuration profile document may be formed including a table containing all possible steps 204.

A configuration profile document is utilized by a generic workflow tool in LOTUS NOTES™ workflow database, determining which of possible steps are to be included in any given customization process. A graphic user interface (GUI) displaying the configuration profile document may be provided to receive desired steps from a user 206. Later on, the agent software builds a new workflow environment based on the configuration profile document containing desired steps of the user.

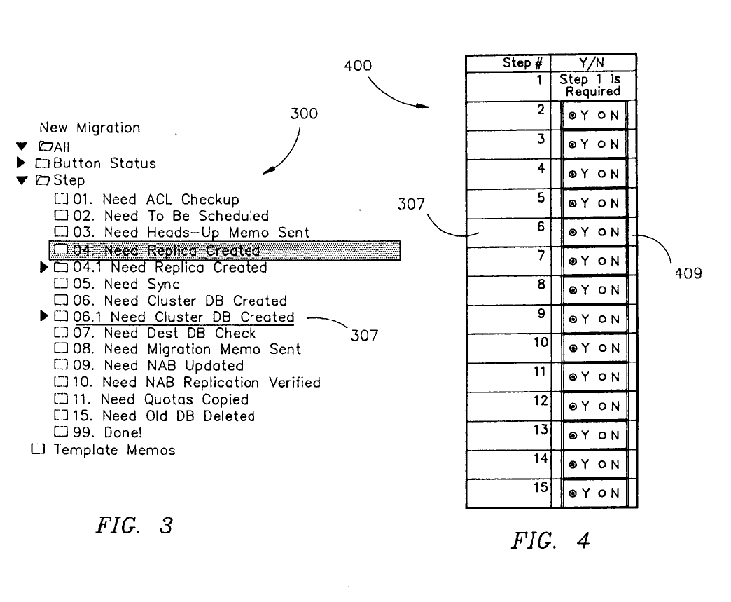

Referring now to FIG. 3, an illustration of a main navigator 300 with all possible migration steps of an E-mail LOTUS NOTES™ system is shown. In general, the standard migration process of an E-mail LOTUS NOTES™ system may contain fifteen possible steps. Each step may comprise a single action by a user such as an administrator. In some instances, the administrator desires to omit certain steps since the administrator considers that some of the actions associated with the steps are not necessary or the administrator desires the actions to be performed by other means. Conventionally, the migration tool for an E-mail LOTUS NOTES™ system manages a configuration profile that determines which of the fifteen possible migration steps are to be included in any given migration effort. Referring now to FIG. 4, an exemplary GUI 400 capable to receive desired steps for a customized migration process of an E-mail LOTUS NOTES™ system is shown. The exemplary GUI 400 provides a table of which element may present a step in the migration process. Each element also comprises a Y/N flag for each step. Preferably, all the Y/N Flags are initially marked to “Y” indicating to include all possible steps for a migration process in the GUI 400. The user (such as the administrator) may provide desired steps via the GUI 400 by deselecting undesirable steps. For example, step six 307 may be deselected by marking the Y/N flag 409 with “N”.

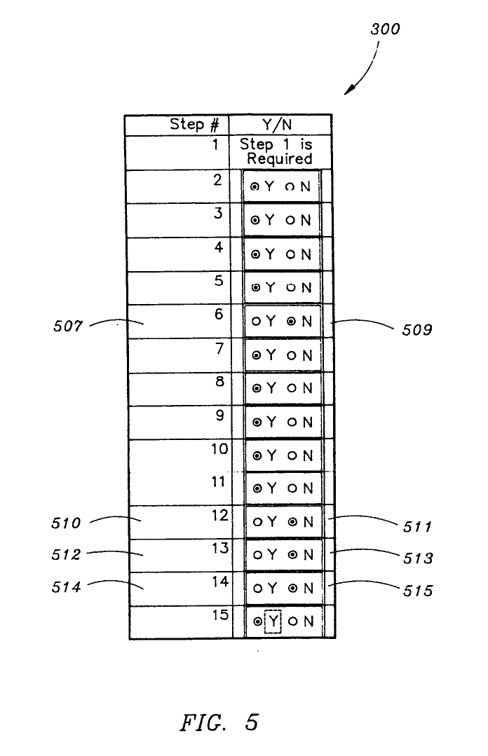

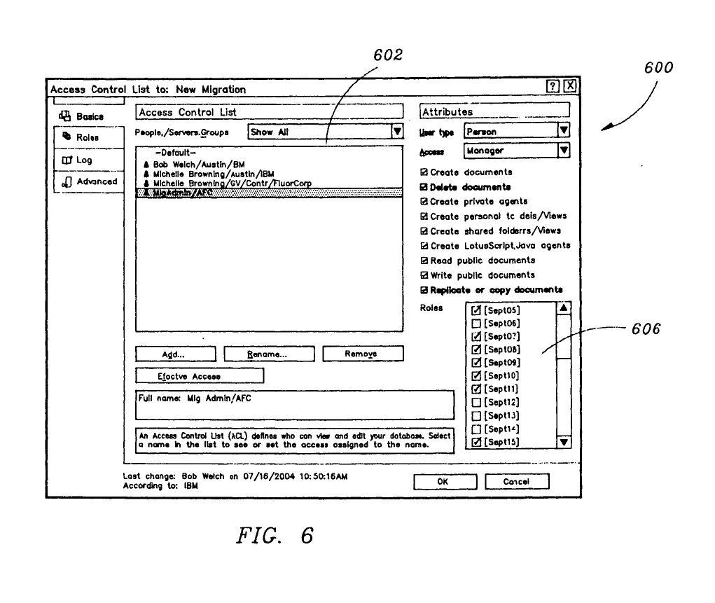

Referring now to FIG. 5, an illustration of the GUI 400 with the desired steps received from the administrator. For example, when the administrator may desire not to include steps six 507, twelve 510, thirteen 512, and fourteen 514, the administrator may mark Y/N flags 509, 511, 513, 515 with “N” indicating that the steps six 507 twelve 510, thirteen 512, and fourteen 514 are not included in the table of the configuration profile document. The configuration profile document may be modified to contain a table of desired steps.

Referring back to FIG. 2, the agent software may store the configuration profile document containing desired step to a local database 210. When the configuration profile document is stored, the agent software may start a customization process 212. The agent software may retrieve user role information from the configuration profile and instruct the generic workflow tool to activate program codes to set roles for all users or groups for a new workflow management system environment based on the user role information. The LOTUS NOTES™ workflow system utilizes a Role Based access control concept which provides centrally controlled access rights and is flexible to enforce policy guidelines for the workflow system. In step 212, the stored configuration profile may be utilized to provide default roles for the administrator.

Referring now to FIG. 6, an illustration of Access Control List screen 600 with user role information of a new customized LOTUS NOTES™ Email migration system is shown. In the LOTUS NOTES™ Email migration system, each step is protected by a unique role. If a role is enabled for a certain user, then the user is allowed to view the step associated with the role. Based on the choices stored in the configuration profile document, the customization agent will instruct LOTUS NOTES™ to execute program codes to change the user roles of the LOTUS NOTES™ Email migration tool. A Roles Window 606 shows user role information after this customization process. In the Roles window 606, the roles for step 5, step 7, step 8, step 9, step 10, step 11 and step 15 are enabled for each user 602 of the newly customized LOTUS NOTES™ Email migration tool. The roles for step 6, step 12, step 13 and step 14 are disabled and therefore these process steps would be hidden from the users.

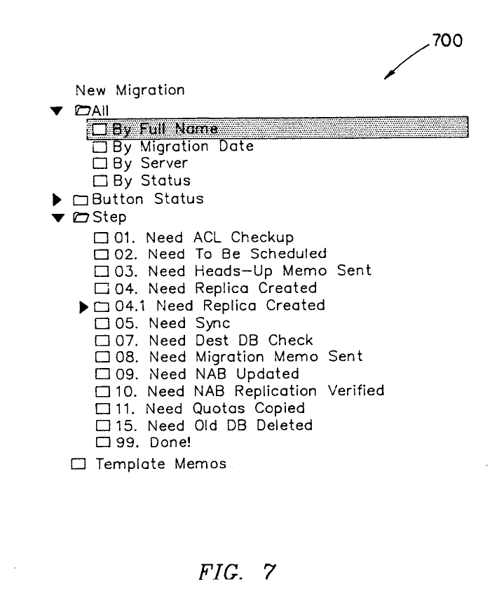

Referring now to FIG. 7, an LOTUS NOTES™ navigator 700 is displayed of the newly customized LOTUS NOTES™ Email migration system. The customized LOTUS NOTES™ Email migration system follows the desired steps for its newly defined workflow process. Advantageously, the present invention maintains the initial database design (provided by a generic workflow application) for a new environment of a customized workflow system. Roles for desired steps may be enabled for users and the document flow (the workflow) may be altered accordingly. In an advantageous aspect of the present invention, the stored configuration profile document may be utilized for various processes offered by the workflow management system. For example, a Work Request in LOTUS NOTES™ may utilize the configuration profile document to determine the order of steps to follow. In FIG. 7, the exemplary LOTUS NOTES™ Email migration system has been customized to include Steps 1-5, 7-11, and 15. When a Work Request document completes the processing at Step 5, Step 7 will be performed.

In an advantageous aspect of the present invention, the actual database design may not be changed as a result of the customization process. Only the workflow between views may be altered in a new workflow environment. In another advantageous aspect of the present invention, a non-developer user (e.g. an administrator) may be able to perform a customization process without writing program codes. Since the database design is not changed, further testing to verify the customized workflow management system may not be necessary. Consequently, the present invention reduces costs and resources to customize an existing workflow management system.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method of an automated customization of a workflow management system, comprising:
storing a template database containing a plurality of process steps for said work flow system;
forming a configuration profile document having a table, said table having a corresponding element for each of said plurality of process steps in said template database;
receiving a selection of desired process steps from a user;
storing said selection of desired steps with said configuration profile document; and
operating said workflow management system according to said configuration profile document.

2. The method as described in claim 1, wherein said workflow management system includes a LOTUS NOTES™ database system.

3. The method as described in claim 2, wherein a user can view a processing step in a database of said LOTUS NOTES™ database system if a role for the processing step is enabled.

4. The method as described in claim 3, said operating step further comprising:
requesting a workflow tool to build a customized database having each of the desired steps included,
wherein the workflow tool disables a role for an undesired step and alters a workflow based on said configuration profile document.

5. The method as described in claim 4, further comprising:
enabling a role for each of the users based on said configuration profile document.

6. The method as described in claim 2, wherein said configuration profile document is utilized to perform a migration process of LOTUS NOTES™ Email system.

7. The method as described in claim 1, said receiving a selection of desired steps step further comprising:
displaying a graphic user interface comprising said table, said table providing a user selectable flag for each of said plurality of process steps,
wherein the user marks said user selectable flag of each desired step.

8. The method as described in claim 1, wherein said customizing step is transparent from said user.

9. A agent software including computer program instructions for an automated customization of a workflow management system, comprising:
means for storing a template database containing a plurality of process steps for said work flow system;
means for forming a configuration profile document having a table, said table having a corresponding element for each of said plurality of process steps in said template database;
means for receiving a selection of desired process steps from a user;
means for storing said selection of desired process steps with said configuration profile document; and
means for operating said workflow management system according to said configuration document file.

10. The agent software as described in claim 9, further comprising:
means for retrieving role information; and
means for building a customized database of a workflow management system based upon said configuration profile document and said retrieved role information,
wherein the role information includes a view permission of each of said plurality of process steps.

11. The agent software as described in claim 9, wherein said workflow management system includes a LOTUS NOTES™ database system.

12. The agent software as described in claim 11, wherein each of said plurality of process steps is represented by a view in a database of said LOTUS NOTES™ database system.

13. The agent software as described in claim 11, further comprising:
means for instructing said workflow management system to build a customized database having each of the desired steps included,
wherein the workflow tool disables a view of an undesired step, enables a view of each of the desired steps and alters a workflow on said customized database.

14. The agent software as described in claim 13, further comprising:
enabling a role for each of the users based on said retrieved role information.

15. The agent software as described in claim 11, wherein said profile document is utilized to perform a migration process of LOTUS NOTES™ Email system.

16. The agent software as described in claim 9, said means for receiving a selection of desired process steps further comprising:
means for displaying a graphic user interface comprising said table, said table providing a user selectable flag for each of said plurality of process steps,
wherein the user selects desired steps by marking said user selectable flag.

17. The agent software as described in claim 10, wherein the role information is retrieved from said configuration profile document.

18. A computer readable medium containing program instructions for providing an automated customization of a LOTUS NOTES™ workflow database system, the program instructions comprising:
storing a template database containing a plurality of process steps for said LOTUS NOTES™ workflow database system;
forming a configuration profile document having a table, said table having a corresponding element for each of said plurality of process steps in said template database;
providing a graphic user interface suitable to receive a selection of desired process steps from a user;
storing said selection of desired process steps with said configuration profile document;
operating said LOTUS NOTES™ workflow database system according to said configuration profile document; and
initiating a plurality of program codes capable to enable views of said desired steps.

19. The computer readable medium as described in claim 18, wherein each said plurality of process steps is represented by a view in a database of said LOTUS NOTES™ database system.

20. The computer readable medium as described in claim 18, wherein said user includes a non-developer user.

21. The computer readable medium as described in claim 18, said operating step further comprising:
instructing said LOTUS NOTES™ workflow database system to initiate said plurality of program codes.

22. The computer readable medium as described in claim 18, further comprising:
enabling a role for each of the users based on said retrieved role information.

23. The computer readable medium as described in claim 22, wherein each of the users can view the plurality of desired steps after the automated customization of a LOTUS NOTES™ workflow database system.

24. The computer readable medium as described in claim 18, wherein said configuration profile document is utilized to perform a migration process of LOTUS NOTES™ Email system.

25. The computer readable medium as described in claim 18, wherein said graphic user interface comprises a table, said table providing a user a selectable flag for each of said plurality of process steps.

26. The computer readable medium as described in claim 25, wherein said user selects said plurality of desired steps marking said selectable flag.
